(19) United States
(12) Patent Application Publication
(10) Pub. No.: US 2021/0276218 A1
(43) Pub. Date: Sep. 9, 2021

(54) METHOD AND SYSTEM FOR PRODUCING AN ENGINEERED WOOD

(71) Applicant: Yong Leong CHANG, Singapore (SG)

(72) Inventor: Yong Leong CHANG, Singapore (SG)

(21) Appl. No.: 16/336,692

(22) PCT Filed: Oct. 5, 2017
(86) PCT No.: PCT/SG2017/050502

§ 371 Date: Mar. 26, 2019

(30) Foreign Application Priority Data
Oct. 5, 2016 (SG) 10201608367P

(51) Int. Cl. B27D 1/08; B27D 1/00; B44F 9/02; B32B 21/14; B32B 21/13; B32B 3/26; B32B 7/12; B32B 37/12; B32B 37/10; B32B 38/04; B32B 37/18; B32B 38/08; B32B 38/00; B27K 3/02; B27K 3/15; C08L 61/06; C08L 97/02

(52) U.S. Cl. CPC B27D 1/083; B32B 2038/166; B44F 9/02; B32B 21/14; B32B 21/13; B32B 3/266; B32B 7/12; B32B 37/1284; B32B 37/10; B32B 38/04; B32B 37/18; B32B 38/08; B32B 38/164; B27K 3/0214; B27K 3/15; C08L 61/06; C08L 97/02; B32B 2307/7265; B32B 2307/3065; B32B 2038/047; B32B 2317/16; B27D 1/005

(57) ABSTRACT

The present invention relates to a method for producing an engineered wood, comprising the steps of: (a) breaking down a veneer to increase its porosity; (b) impregnating the veneer from step (a) with an adhesive material; (c) drying the veneer from step (b) to a predetermined moisture content level; (d) arranging a plurality of the veneers from step (c) in a mould; and (e) pressing the plurality of the veneers in the mould. The engineered wood has an appearance of natural timber, and is able to withstand extreme weather conditions and have minimum warping, rotting and termite infestation.

### TECHNICAL FIELD OF THE INVENTION

The invention described herein pertains generally to using wood fibre to produce engineered wood (also known as composite wood, man-made wood, artificial wood or manufactured board).

### BACKGROUND OF THE INVENTION

The following discussion of the background to the invention is intended to facilitate understanding of the present invention. However, it should be appreciated that the discussion is not an acknowledgment or admission that any of the material referred to was published, known or a part of the common general knowledge in any jurisdiction as at the priority date of the application.

The supply of natural timber has significantly decreased over the years and it is of increasing difficulty to obtain natural hardwood of substantial width and length in the market. Also, there are common issues arising from using natural timber, such as warping, rotting, and susceptibility to termite infestation.

Engineered wood (also known as composite wood, man-made wood, artificial wood or manufactured board) has been used as a substitute matter to address the shortage and disadvantages of natural timber.

The conventional derivatives of engineered wood include plywood, medium-density fibreboard, glued laminated timber (glulam), reconstituted veneer, laminated veneer lumber (LVL), finger-jointed lumber, parallel strand lumber and cross-laminated timber. Some examples of the engineered wood are introduced below:

Reconstituted Veneer: reconstituted veneer is derived from a wood block produced by way of stacking veneer sheets together. It is then sliced into veneer form. Reconstituted veneer is in general made from fast-growing tropical wood species. The raw veneer sheet used for producing the reconstituted veneer is peeled from a log, and dyed if necessary. Once dyed, the raw veneer sheets are laminated together to form a block. The block is then sliced so that the edges of the laminated veneer become the “grain” of the reconstituted veneer. A known reconstituted veneer in general has a thickness of 0.2 mm to 1 mm, and is mainly used for decorative purposes, such as decorating surface of furniture. Other properties of known reconstituted veneers such as strength, durability, water-resistance, fire-resistance and termite-resistance are generally not concerned in the production and application of such reconstituted veneers.

Laminated Veneer Lumber: Laminated Veneer Lumber (LVL) refers to an engineered wood product that uses multiple layers of thin wood assembled with adhesives. The thickness of a wood layer for LVL usually ranges from 1.2 mm-2.2 mm. As compared to natural timber, LVL is in general stronger, straighter and dimensionally more stable. However, LVL is of similar appearance to plywood (showing distinct layers of veneers) and therefore typically used for headers, beams, rim board and edge-forming material. Furthermore, the LVL veneers are in general pressed and assembled together without receiving any further treatment, thus known LVL does not possess properties such water-resistance and termite-resistance.

Engineered wood is now often used as a cheaper substitute to solid wood product due to its versatility, availability in wide variety of sizes and in some cases, greater strength and stiffness as compared to, for example, natural medium hardwood. However, as mentioned above, while the engineered wood is dimensionally more stable than the solid natural timber, the conventional derivatives of known engineered wood are not able to withstand exposure to extreme weathering or high moisture content. For example, the conventional engineered wood still expands and contracts with humidity and moisture content fluctuations.

Also, a block of engineered wood material such as plywood and laminated veneer lumber differs from solid natural timber in appearance. With the conventional technologies of engineered wood, one would still be able to tell that an engineered wood product is artificial/man-made from, for example, the distinct layers of veneers/timbers that are bound together. Moreover, on the surface layer of the engineered wood, the appearance of the engineered wood product is highly dependent on the species of the natural timber used to create the veneers. As such, the engineered woods do not have a natural appearance, showing distinct layers of veneers/timbers. The conventional derivatives of engineered wood therefore cannot substitute the natural wood in producing wood products in terms of appearance.

Further, it is difficult to process some conventional engineered woods such as reconstituted veneer and LVL using conventional wood working tools or machines.

In sum, the conventional derivatives of known engineered wood cannot totally substitute the natural timber with regards to appearance, cannot withstand extreme weather conditions or high moisture content, and cannot be easily processed using conventional wood working tools or machines.

Thus, there exists a need to develop an engineered wood that at least alleviates some of the above technical problems.

### SUMMARY OF THE INVENTION

In accordance with an aspect of the present invention, there is a method of producing an engineered wood, comprising the steps of: (a) breaking down a veneer to increase its porosity; (b) impregnating the veneer from step (a) with an adhesive material; (c) drying the veneer from step (b) to a predetermined moisture content level; (d) arranging a plurality of the veneers from step (c) in a mould; and (e) pressing the plurality of the veneers in the mould. The method of the present invention achieves a strong bonding among the veneer layers. Breaking down the veneer creates micro-channels between each veneer layer for resin (or other types of adhesive materials) to seep through, which creates a “stitch” effect between the veneer layers when the impregnated resin (or other types of adhesive materials) reacts with the veneers when cured. The method of the present invention also creates pores (i.e. “artificial wood pores”) that resemble the wood pores that occur in natural timber. With such artificial wood pores, the engineered wood product produced by the method of the present invention resembles natural timber.

In accordance with another aspect of the present invention, there is an engineered wood formed from a plurality of veneers, wherein each of the plurality of veneers comprises a plurality of fully-penetrated holes, and an adhesive material adapted to bind the plurality of veneers together by filling the plurality of fully-penetrated holes. The layers of veneers in the present invention are strongly bonded together to form a solid wood block similar to natural timber because the adhesive material can bind the veneers firmly together through micro-channels formed by the holes. Due to the strong and stable binding among the veneer layers, the engineered wood of the present invention can withstand harsh weather conditions and have minimum warping. The engineered wood of the present invention also has further technical advantages such as resistance to fire, moisture and termite infestation. The present invention is also suitable to be moulded, routed, carved, sanded and/or bonded.

In accordance with another aspect of the present invention, there is an engineered wood produced from a method according to an aspect of the present invention. The engineered wood of the present invention achieves a strong bonding among the veneer layers. Breaking down the veneer creates micro-channels between each veneer layer for resin (or other types of adhesive materials) to seep through, which creates a “stitch” effect between the veneer layers when the impregnated resin (or other types of adhesive materials) reacts with the veneers when cured. The method of the present invention also creates pores (i.e. “artificial wood pores”) that resemble the wood pores that occur in natural timber. With such artificial wood pores, the engineered wood product produced by the method of the present invention resembles natural timber.

Other aspects of the invention will become apparent to those of ordinary skill in the art upon review of the following description of specific embodiments of the invention in conjunction with the accompanying figures.

### BRIEF DESCRIPTION OF THE DRAWINGS

The invention will now be described, by way of example only, with reference to the accompanying drawings, in which:

FIG. 1 shows an illustrative flowchart of the three phases (veneer processing phase, pressing phase and curing phase) of an embodiment of the present invention.

FIG. 2 shows an illustrative flowchart of the manufacturing steps in the veneer-processing phase of an embodiment of the present invention.

FIG. 3 shows an illustrative flowchart of the manufacturing steps in the pressing phase of an embodiment of the present invention.

FIG. 4 shows an illustrative flowchart of the manufacturing step in the curing phase of an embodiment of the present invention.

FIG. 5 shows a lateral view of an embodiment of the present invention and a lateral view of a known Laminated Veneer Lumber.

FIG. 6 shows exotic wood species that an engineered wood according to an embodiment of the present invention, are molded to resemble.

FIG. 7 shows a perspective view of a conventional derivative of known engineered wood comprising layers of veneers bonded together using adhesives.

FIG. 8 shows a perspective view of an embodiment of the present invention.

FIG. 9 shows a perspective view of a perforated veneer and an unperforated veneer.

FIG. 10 shows an embodiment of the present invention and an Australian hardwood left in a termite nest in Darwin Australia for six months.

FIG. 11 shows an illustrative front view of a perforation machine having three studded wheels and one non-studded wheel.

FIG. 12a shows an illustrative lateral view of a fully-penetrated hole/pore.

FIG. 12b shows an illustrative top view of a portion of a perforated veneer.

FIG. 13a shows an illustrative lateral cross-sectional view of a container having a mould with layers of veneers.

FIG. 13b shows an illustrative longitudinal cross-sectional view of a container having a mould with layers of veneers.

FIG. 13c shows a top perspective view of a container having a mould with layers of veneers.

FIG. 14a shows a mould that is designed to mimic the natural grains of Burmese teak tree.

FIG. 14b shows a mould that is designed to mimic the natural grains of white oak tree.

Other arrangements of the invention are possible and, consequently, the accompanying drawings are not to be understood as superseding the generality of the preceding description of the invention.

### DETAILED DESCRIPTION

Particular embodiments of the present invention will now be described with reference to the accompany drawings. The terminology used herein is for the purpose of describing particular embodiments only and is not intended to limit the scope of the present invention. Additionally, unless defined otherwise, all technical and scientific terms used herein have the same meanings as commonly understood by one or ordinary skill in the art to which the present invention belongs. Where possible, the same reference numerals are used throughout the figures for clarity and consistency.

Throughout the specification, unless otherwise indicated to the contrary, the terms “comprising”, “consisting of”, and the like, are to be construed as non-exhaustive, or in other words, as meaning “including, but not limited to”.

Throughout the specification, unless the context requires otherwise, the word “comprise” or variations such as “comprises” or “comprising”, will be understood to imply the inclusion of a stated integer or group of integers but not the exclusion of any other integer or group of integers.

Throughout the specification, unless the context requires otherwise, the word “include” or variations such as “includes” or “including”, will be understood to imply the inclusion of a stated integer or group of integers but not the exclusion of any other integer or group of integers.

As used herein, the term “about” typically means +/−5% of the stated value, more typically +/−4% of the stated value, more typically +/−3% of the stated value, more typically +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as a limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. Ranges are not limited to integers, and can include decimal measurements. This applies regardless of the breadth of the range.

Throughout the description, unless the context requires otherwise, the term “natural wood” or “natural timber” refers to wood that is obtained from a woody plant (e.g. a tree or a shrub). This can include chemical drying, painting, pressure treating, or any other form of artificial modification to the wood beyond simply drying and cutting it.

Throughout the description, the term “veneer” refers to a layer or a sheet of wood having a length, width and height/thickness. In the context of the present invention, the preferred thickness of a veneer is in a range of about 0.5 mm to about 3 mm. A veneer can be of different shapes. Preferably the veneer has a polygonal (e.g. square, rectangular, etc.) shape.

Throughout the description, the term “resin” refers to an amorphous solid or semisolid or viscous substance, and includes natural resin and synthetic resin. Examples of resin include, but are not limited to, polyesters, polyacrylates, polyurethanes, polyamides, polylactones, polycarbonates, polyolefins, alkyds, oil-modified alkyds, epoxy resins (such as epoxy-unsaturated fatty acid ester resins), addition resins with pendent olefinic groups, condensation resins with pendent olefinic groups, lacquer resins, cellulose esters, melamine resin, phenolic resin, bio-based resin (e.g., derived from soy bean) and a combination thereof.

Throughout the description, the term “pore” or “hole” refers to an opening/aperture on a surface of a veneer, through which fluids may pass. Throughout the description, the term “porosity” refers to a measure of the void (i.e. “pore”, “hole”) spaces in a material (e.g., a veneer), and is a ratio of the volume of void spaces to the total volume (which includes the volume of the material and the void spaces), and can for example be expressed as a value between the integers 0 and 1, or as a percentage between 0% and 100%. In the context of the present invention, the pore or hole may be in an elliptical cylindrical, cylindrical, conical, frusto-conical, frustum or cuboid shape (or substantially elliptical cylindrical, cylindrical, conical, frusto-conical, frustum or cuboid shape), which has a depth that corresponds to the thickness of each veneer.

Throughout the description, the term “moisture content level” refers to the amount of water in a composition, and can be expressed as a ratio (e.g., weight/weight), a percentage or other forms known to a skilled person.

Throughout the description, the term “natural appearance” refers to the boundaries between layers of veneers/timbers that are naturally blended, merged, fused together, thereby simulating boundaries between natural growth rings of woody plants. The boundaries of “natural appearance” are in clear contrast to those distinct, straight-line, artificially-looking boundaries between layers of veneers/timbers in the conventional plywoods and Laminated Veneer Lumbers. The present invention relates to using wood fibres to produce an engineered wood. Engineered wood may also be referred to as composite wood, artificial wood, man-made wood or manufactured board, and these terms can be used interchangeably in the specification herein. An engineered wood is a composite product produced from the piecing and adhering together of pieces or fragments of wood (not limited to natural or treated wood and can include other engineered wood), such as binding fibres, veneers or boards of wood, through the use of adhesives, such as a resin. Examples of resin include, but are not limited to, polyesters, polyacrylates, polyurethanes, polyamides, polylactones, polycarbonates, polyolefins, alkyds, oil-modified alkyds, epoxy resins (such as epoxy-unsaturated fatty acid ester resins), addition resins with pendent olefinic groups, condensation resins with pendent olefinic groups, lacquer resins, cellulose esters, melamine resin, phenolic resin, bio-based resin (e.g., derived from soy bean) and a combination thereof.

### Embodiments of the Present Invention

An embodiment of the present invention relates to a method of producing an engineered wood, comprising the steps of: (a) breaking down a veneer to increase its porosity; (b) impregnating the veneer from step (a) with an adhesive material; (c) drying the veneer from step (b) to a predetermined moisture content level; (d) arranging a plurality of the veneers from step (c) in a mould; and (e) pressing the plurality of the veneers in the mould. The method of the present invention achieves a strong bonding among the veneer layers. Breaking down the veneer creates micro-channels between each veneer layer for resin (or other types of adhesive materials) to seep through, which creates a “stitch” effect between the veneer layers when the impregnated resin (or other types of adhesive materials) reacts with the veneers when cured. The method of the present invention also creates pores (i.e. “artificial wood pores”) that resemble the wood pores that occur in natural timber. With such artificial wood pores, the engineered wood product produced by the method of the present invention resembles natural timber.

Another embodiment of the present invention relates to an engineered wood formed from a plurality of veneers, wherein each of the plurality of veneers comprises a plurality of fully-penetrated holes, and an adhesive material adapted to bind the plurality of veneers together by filling the plurality of fully-penetrated holes. The layers of veneers in the present invention are strongly bonded together to form a solid wood block similar to natural timber because the adhesive material can bind the veneers firmly together through micro-channels formed by the holes. Due to the strong and stable binding among the veneer layers, the engineered wood of the present invention can withstand harsh weather conditions and have minimum warping. The engineered wood of the present invention also has further technical advantages such as resistance to fire, moisture and termite infestation. The present invention is also suitable to be moulded, routed, carved, sanded and/or bonded.

Another embodiment of the present invention relates to an engineered wood produced from a method according to an embodiment of the present invention. The engineered wood of the present invention achieves a strong bonding among the veneer layers. Breaking down the veneer creates micro-channels between each veneer layer for resin (or other types of adhesive materials) to seep through, which creates a “stitch” effect between the veneer layers when the impregnated resin (or other types of adhesive materials) reacts with the veneers when cured. The method of the present invention also creates pores (i.e. “artificial wood pores”) that resemble the wood pores that occur in natural timber. With such artificial wood pores, the engineered wood product produced by the method of the present invention resembles natural timber.

The Manufacturing Process: Method of Producing an Engineered Wood

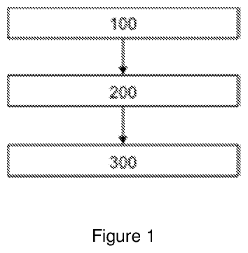

In an embodiment of the present invention, the manufacturing process comprises three general phrases: veneer-processing phase 100, pressing phase 200 and curing phase 300 (FIG. 1). The detailed steps within each phase are elaborated below using poplar veneer as an example of the raw veneer material. In other embodiments of the invention, other types of suitable veneer materials such as rubber wood, Albicia Falcata, Eucalypt. Pine, Acacia, Birch, Beech, Paulownia, Meranti, Kapur, Merbau and Balau may be used.

In the following embodiment of the manufacturing process, the adhesive material used to bind layers of veneers together is a resin. Examples of resin include, but are not limited to, polyesters, polyacrylates, polyurethanes, polyamides, polylactones, polycarbonates, polyolefins, alkyds, oil-modified alkyds, epoxy resins (such as epoxy-unsaturated fatty acid ester resins), addition resins with pendent olefinic groups, condensation resins with pendent olefinic groups, lacquer resins, cellulose esters, melamine resin, phenolic resin, bio-based resin (e.g., derived from soy bean) and a combination thereof. Preferably, the resin is a water-soluble phenolic resin.

Veneer-Processing Phase (100)

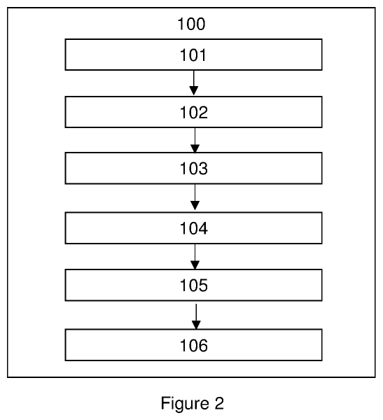

The Veneer-Processing Phase 100 will be described in more detail as follows, with reference to FIGS. 2, 11 and 12 (12a, 12b).

Step 1: Peeling of Plantation-Poplar Wood (101)

At a sawmill, a poplar veneer is produced through the peeling of plantation-poplar wood. In a preferred embodiment of the invention, the peeling process is facilitated by a rotary lathe in which the raw wood is turned against one or more blades and peeled off in one continuous or semi-continuous roll. A general rotary peeling machine is suitable for this process. In an alternative embodiment of the invention, the peeling process is facilitated by a slicing machine in which the flitch or piece of log is raised and lowered against the blade and slices of the log are made. Such slicing machine yields veneer that looks like sawn pieces of wood, cut across the growth rings; such veneer is referred to as “crown cut”. Each veneer is processed to have a thickness of about 0.5 millimetre (mm) to about 3.0 mm. In a preferred embodiment of the invention, each veneer is processed to have a thickness of about 0.5 mm to about 1.2 mm.

Step 2: The First Drying of Poplar Veneer (102)

A poplar veneer from Step 1 (101) is dried either by air or in a drying chamber. In a further embodiment of the invention, the poplar veneer is dried to achieve a particular moisture content level so that the veneer can effectively absorb the resin in Step 5 (Impregnating resin into veneer) (105). In some preferred embodiments of the invention, the veneer is dried to have a moisture content of about 5% to about 18%.

Step 3: Trimming (103)

In a further embodiment of the invention, a poplar veneer from Step 2 (102) is trimmed to a predetermined width (e.g., about 150 mm to about 600 mm). In a preferred embodiment of the invention, the predetermined width is in a range of about 150 mm to about 300 mm.

Step 4: Breaking Down the Veneer (104)

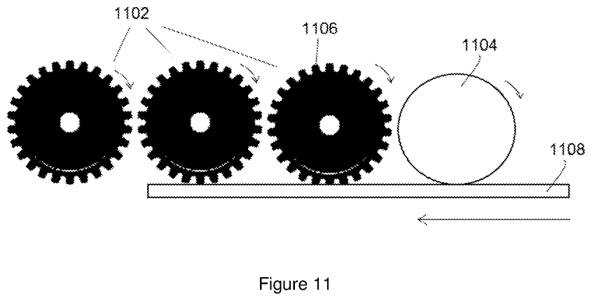

Each piece of veneer is individually processed through a perforation machine (FIG. 11) to increase the porosity of the veneer and to break down the veneer into softer veneer fibres 802. In a further embodiment of the invention, a plurality of veneers is processed together through the perforation machine to increase the porosity of the plurality of veneers.

Such process includes but is not limited to perforating the veneer throughout with numerous holes/pores 804. The holes/pores may be formed by one or more studded wheels (or spiked rollers) 1106, preferably at least two (2) studded wheels (or spiked rollers) 1102.

In a further embodiment of the invention, the number of studs (or spikes) 1106 on each wheel (or roller) 1102 will depend on the porosity required. Preferably the number of studs (or spikes) 1106 on each wheel (or roller) 1102 range from 80 to 200 studs (or spikes). The studs (or spikes) 1106 can be randomly arranged across the exterior surface of the wheel (or roller) 1102 to achieve random distances among the artificial holes or pores 804 to simulate natural wood pores, or the studs (or spikes) 1106 can be arranged in an orderly manner to achieve even distribution of the holes or pores 804 on the veneer. Alternatively, the studs (or spikes) 1106 can be arranged on the exterior surface of the wheel (or roller) 1102 based on a combination of random and orderly arrangement. In a further embodiment, there are at least five (5) studs (or spikes) 1106 per square centimetres (cm²) of an exterior surface of a roller (or wheel) 1102.

The density of studs (or spikes) on the wheel (or roller) affects the density of pores/holes on the veneers. Feeding a veneer through the perforation machine multiple times can increase the porosity (i.e., density of pores) of the veneer 802. Thus, depending on the density of studs (or spikes) on the wheel/roller and the number of times each veneer goes through the perforation machine, the density of the pores/holes on the perforated veneers can be obtained (e.g., via estimation or calculation). In a preferred embodiment of the invention, the pores/holes 804 formed are randomly arranged across the veneer surface, and there are at least five (5) pores/holes 804 per cm² (square centimetres) of the veneer surface.

In a further embodiment of the invention as illustrated in FIG. 11, the perforation machine comprises four rollers (1102 & 1104), out of which three rollers have studs (or spikes) 1106. The roller without studs/spikes 1104, when rotating (e.g., in clockwise direction as illustrated in FIG. 11), functions to drive the veneers through the perforation machine, so that the veneers can undergo perforation by the three studded/spiked rollers 1102.

In a further embodiment of the invention, each stud (or spike) 1106 is of sufficient length and size to fully penetrate one or more veneers to create holes or pores 804 that run through the one or more veneer, i.e. the holes/pores 804 penetrate through the depth/thickness of the veneer 802.

In various other embodiments, the holes/pores may be formed by at least one laser operable to perforate one or more veneers, sequentially or concurrently. Lasers are capable of forming holes/pores that are substantially uniform in shape and size. Further, the hole/pores may be advantageously arranged at substantially uniform distance from one another and/or be arranged in a substantially ordered manner. Such uniformity could advantageously enhance the “stitch” effect of the cured resin that binds the veneers together through these holes/pores.

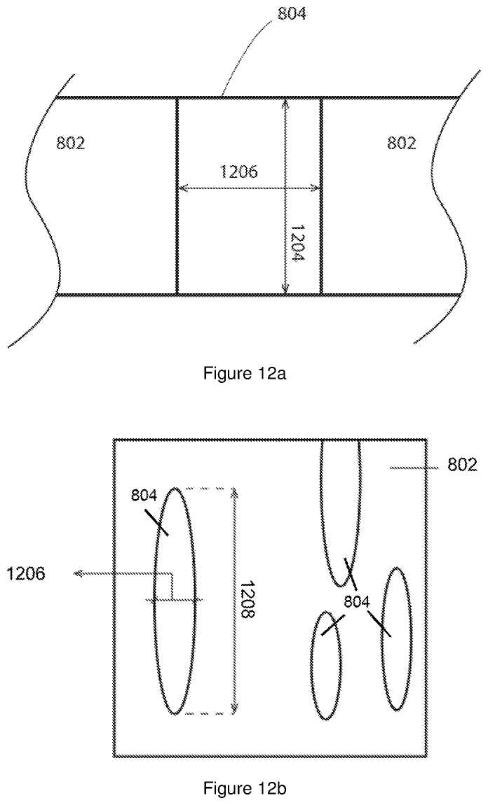

In a further embodiment of the invention, each pore or hole 804 is a cylinder having an elliptical cross-sectional shape when viewing from the planar side of a veneer. Each pore or hole 804 has a depth 1204 (FIG. 12a), a surface length (i.e. length of the major axis) 1208, and a surface width (i.e. length of the minor axis) 1206 (FIG. 12b). The depth 1204 ranges from about 0.5 mm to about 3 mm depending on the thickness of the veneer 802. In a preferred embodiment of the invention, the holes and pores 804 have a depth 1204 ranging from about 0.5 mm to about 1.2 mm depending on the thickness of the veneer 802. In a further embodiment of the invention, the holes or pores 804 have an elliptical cross-sectional shape as shown in FIG. 12b where each pore or hole 804 has a surface length (i.e. length of the major axis) 1208 ranging from about 2 mm to about 5 mm, and a surface width (i.e. length of the minor axis) 1206 ranging from about 0.2 mm to 1 mm. It will be appreciated that the holes or pores 804 in the veneer can have the same surface dimensions (i.e., surface width and surface length) or varying surface dimensions within the range of about 2 mm to about 5 mm for the surface length and the range of about 0.2 mm to 1 mm for the surface width.

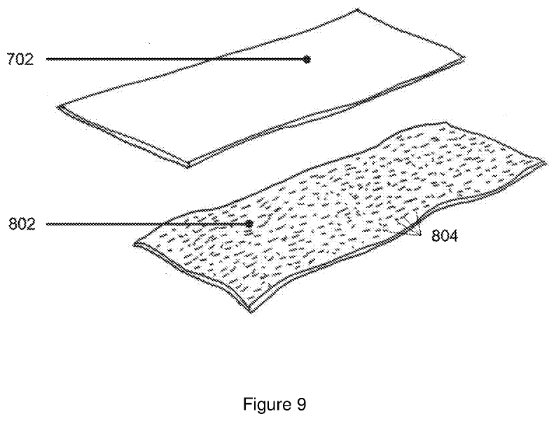

The veneer fibres in the processed veneer 802 are still intact but are softer in their tensile strength (FIG. 9). In one embodiment of the invention, the breaking-down process of Step 4 (104) breaks down the fibres of the veneer but only to the extent that the fibres of the veneers remain connected, which ensures that the veneers 802 can still be handled or moved as a single piece.

In contrast to an unprocessed veneer 702 that is stiff with tension, the numerous artificial holes and pores on the processed veneer 802 weaken the tension among the fibres and between the veneer layers, making it easier to process/shape the veneers 802 (e.g., press the veneers in a mould), and to form micro-channels for resin to seep through, which when cured, improves the stability of the end product.

Step 4 (104) helps the veneer layers 802 to achieve a strong bonding between each veneer layer at the press phase 200. Forming holes/pores 804 (e.g. through punching and/or perforation) within the veneer 802 creates micro-channels 804 across layers of veneers for resin (or other types of adhesive materials) to seep through—in this step 4 (104), the holes/pores are also considered micro-channels, and therefore can be referred to as the same feature. As the resin (or other types of adhesive materials) seeps through multiple layers of veneers via the micro-channels 804, a “stitch” effect will be created among the veneer layers 802 when the impregnated resin (or other types of adhesive materials) reacts with the veneers during the curing phrase 300.

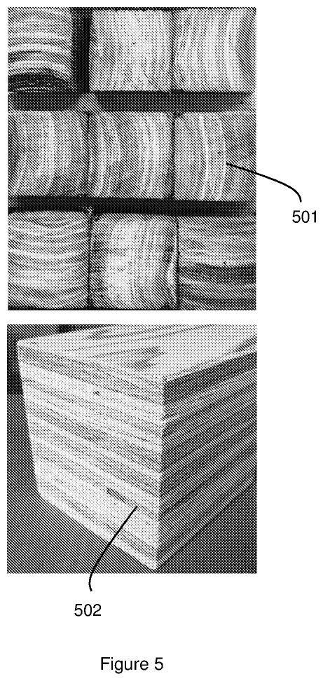

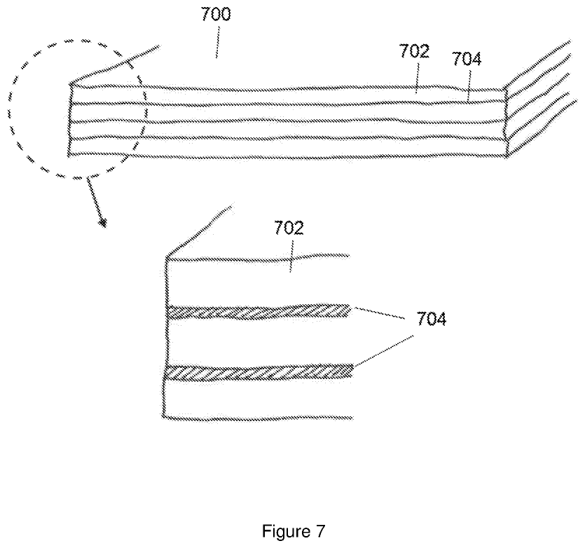

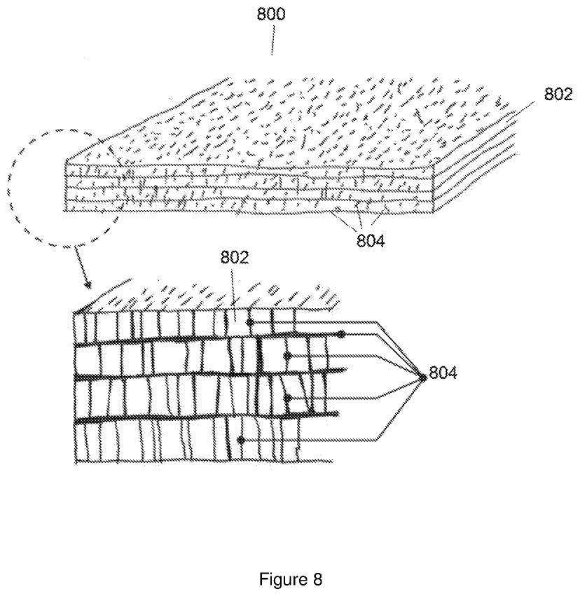

The holes/pores 804 created from process 104 (i.e., “artificial wood pore”) also resemble wood pores occurring in natural timber (501, FIG. 5). With such artificial wood pores, neighbouring veneer layers, when pressed and assembled together in the following steps, will have boundaries that have a natural appearance similar to the annual growth rings observed in a natural wood (501; 804). In clear contrast, the neighbouring veneer layers in conventional engineered wood such as LVL and plywood in general have distinct straight-line boundaries that look unnatural and artificial (502, FIG. 5; 704, FIG. 7).

Step 5: Impregnating Resin into Veneer (105)

Layers of veneers from Step 4 (104) are then gathered into a steel cage and lowered into a resin pool for the veneers to be impregnated with a resin. The resin can exist in either solid or semisolid state. In various embodiments, the resin is a phenol formaldehyde polymer that is water based, preferably comprising less than 2% phenol and/or less than 1% formaldehyde. In various embodiments, the resin has a pH range of 9.0-10.0; a viscosity (dynamic) at 25° C. of 20 mPa·s-50 mPa·s (i.e. 20 cP to 50 cP); and a density of 1.18 g/cm³-1.20 g/cm³. Preferably, the resin has a viscosity (dynamic) at 25° C. of 30 mPa·s (i.e. 30 cP).

The veneer is soaked in the resin pool for a predetermined period of time (e.g., about 12 to about 24 hours) before being removed for drying. Veneers that are impregnated with resin may appear to be in a brown colour as compared to the original veneers.

In other embodiments, the veneers may be individually soaked and/or impregnated with resin before being gathered and arranged together.

In a further embodiment of the invention, the viscosity of the resin has a working range from about 5 to about 30 cP (centipoise). A person skilled in the art would know how to convert values with the units “cP” to the pascal-second (Pa·s), or (N·s)/m², or kg/(m·s).

In a further embodiment of the invention, Step 5 (105) is facilitated by a vacuum pressure impregnation chamber that uses vacuum and pressure to seal porous materials (veneers with holes/pores) with resin. Use of vacuum pressure improves the impregnation of resin into the veneers. The stronger the vacuum, the more resin can be absorbed into the veneers—the pressure forces the resin deep into the veneers. Step 5 (105) can be expedited to from about 12 to about 24 hours to just about 3 to about 4 hours if the veneer (e.g., poplar) is placed in a vacuum pressure impregnation chamber. Depending on the permeability of the veneers and the requirements, the duration and pressure level of the vacuum pressure impregnation can be adjusted.

As the veneers from Step 4 (104) have been perforated through with numerous holes/pores, when such veneers are soaked in the resin pool, the resin will fill in and seal the holes/pores 804. In other words, the veneers will absorb the resin much better, and be fully immersed with the resin. Once the resin solidifies, the resin can then bind the layers of veneers firmly together and function to prevent the penetration of water and infestation of termites in the final engineered wood. For example, even when water molecules or termites somehow manage to penetrate into the surface of a veneer layer, the water molecules and the termites are not able to spread further through the veneer as the micro-channels (or holes/pores) 804 are filled with resin (or other types of adhesive) that is resistant to water/fire/termite when cured. Such resin in the micro-channels can therefore block the water molecules and termites from spreading further through the veneer. The end product of the present invention is therefore able to resist moisture, fire and termites.

In clear contrast, in conventional engineered wood, the resin only covers the interface 704 between the adjacent veneers 702. Thus, even when resin 704 having water-resistant, fire-resistant and/or termite-resistant properties are applied to assemble the veneers 702 together, the end product of the convention engineered wood is still unlikely to have satisfactory water/fire/termite-resistant properties, as the veneers 702 themselves are still susceptible to moisture, fire and termite. For example, water molecules and termites can still penetrate into the veneers, as the resin only cover the interfaces between the veneers.

Step 6: The Second Drying of Veneer (106)

Each impregnated veneer would be placed into a drying chamber. In one embodiment of the invention, the drying chamber has a conveyor belt that drives the impregnated veneer through the chamber. The drying chamber has a mechanism that controls the moisture content level within each veneer. Once a veneer exits the drying chamber, it would achieve the desired moisture content level. The processed veneer will then be aligned into boxes, ready for the next phase of production.

The speed of the conveyor belt and the temperature of the drying chamber can be adjusted to help the impregnated veneer achieve the desired moisture content level. In a further embodiment of the invention, the drying chamber is equipped with a moisture sensor to measure the moisture content level of the impregnated veneer.

In some alternative embodiments of the invention, the impregnated veneer is air-dried. In a further embodiment of the invention, the impregnated veneer in the second drying process is protected from ultraviolet light, as UV light may damage the strength of resin bonding. In addition, ultraviolet light may cause premature curing of the resin prior to or during the drying process.

In a further embodiment of the manufacturing, an additional step of veneer-inspection is performed to remove veneers of inferior quality or with defects after Step 6 (106). For example, veneers with dead knots are considered defective veneers, and might cause difficulties in the downstream processing steps (e.g., pressing, arranging and curing the veneers). Only veneers that are in good condition (e.g., absence of dead knots) are packed for the next phase (pressing phase 200), while veneers with dead knots are removed and repaired. Dead knots and/or undesirable stained veneers may be removed/excised by means known in the art, which include but are not limited to manual excision, automated excision using hydraulic/pneumatic press systems, and laser means.

Press Phase (200)

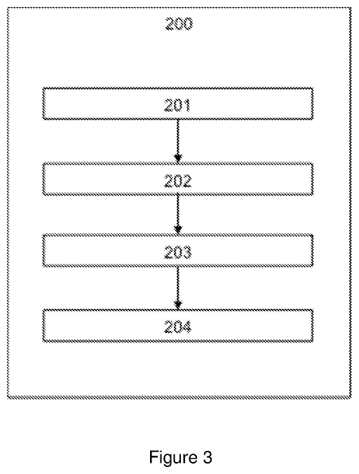

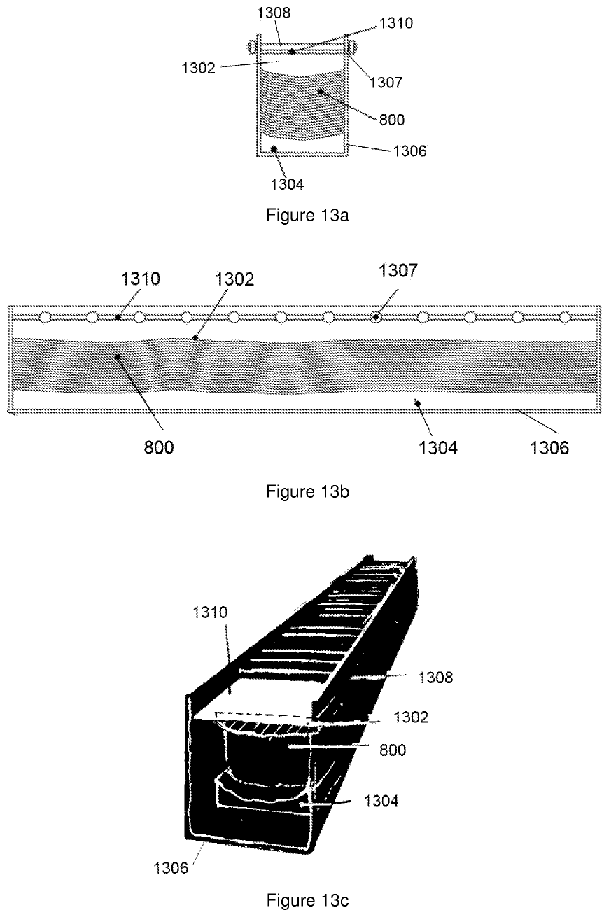

The Press Phase 200 will be described in more detail as follows, with reference to FIGS. 3, 13a, 13b and 13c.

Step 7: Selecting a Mould for Pressing (201)

Based on the production order that specifies a particular wood grain pattern, a suitable mould is applied to produce the wood grain pattern on the veneers.

In a further embodiment of the invention, the selected mould comprises a male portion 1302 and a female portion 1304 which are complementary—in particular, the surfaces of the male 1302 and female 1304 portions which are in contact with the veneers (i.e., in operation, layers of veneers are held in-between the male portion 1302 and female portion 1304), are complementary to one another, akin to a key and a lock. In other words, the surfaces of the male portion 1302 and female portion 1304 are configured to perfectly mate with each other when there is no veneer in-between them.

In a further embodiment of the invention, the contours of the surfaces of the male 1302 and female 1304 portions are designed to simulate the growth ring patterns of natural woods (e.g., the wood grain patterns). Therefore, the design of the contours depends on the species of natural wood which the engineered wood is manufactured to mimic.

In a further embodiment of the invention, the surface of the male 1302 portion is substantially convex, and the surface of the female portion 1304 is substantially concave, and when being combined together, the surfaces of the male portion 1302 and female portion 1304 are complementary and preferably in perfect match. When in use, the male portion 1302 and female portion 1304 create a curvature in the veneer block 800 which conforms to the curvature of the convex surface of the male portion 1302 and the concave surface of the female portion 1304, such that the veneer block 800 is capable of simulating a portion or section of a natural tree trunk.

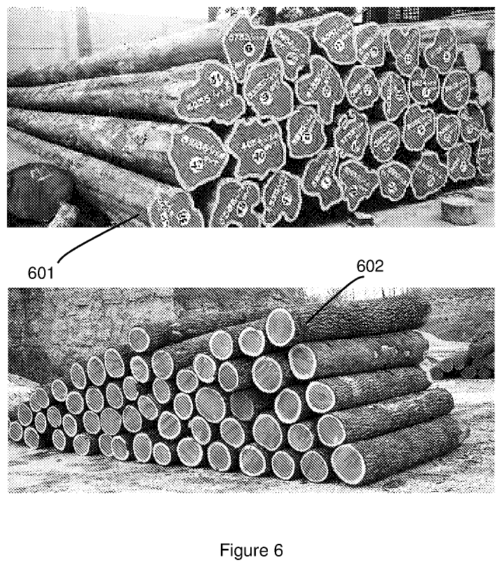

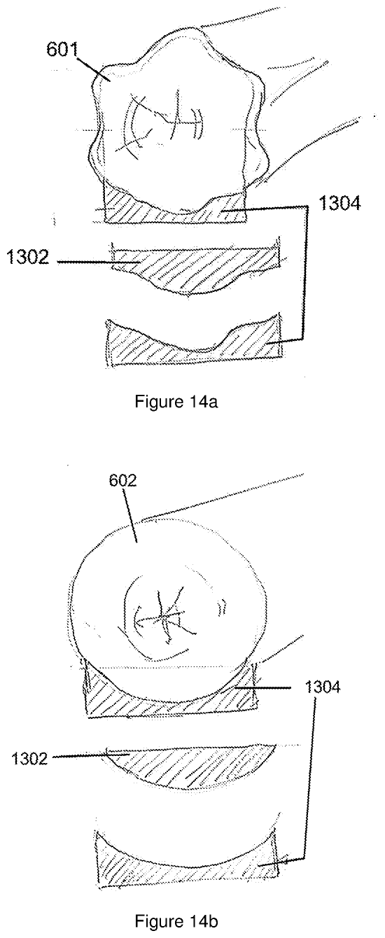

In a further embodiment of the invention, the mould is produced by a robotic CNC (computer numeric control) machine to simulate a variety of wood growing contours, for example mimicking the exotic wood species of FIG. 6. Specifically, a mould is created by 3D model software and 3D contour software. As illustrated in FIG. 14 (14a, 14b), the shape of the female portion 1304 simulates the grain patterns of a natural tree trunk (e.g., Burmese teak, white oak). For example, the female portion 1304 that mimics the Burmese teak 601 in general has an uneven circumference (FIG. 14a), and the female portion 1304 that mimics the white oak tree 602 in general has a half-rounded shape (FIG. 14b). In a further embodiment of the invention, once the design of the female portion 1304 is determined, the male portion 1302 is developed accordingly to complement the female portion 1304.

Therefore, depending on the mould chosen, the end product may resemble a portion of a natural wood log, and display the appearance of exotic wood species regardless of its original material (e.g., an economic sustainable plantation wood species).

In a further embodiment of the invention, the mould (i.e. male 1302 and female portions 1304) is made of materials that are hard, have high tensile strength and high heat-resistance such as steel and other suitable metal alloys. In a further embodiment of the invention, the mould is made of wood.

Step 8: Weighing the Veneers (202)

Once a suitable mould is selected, the veneers for producing a single block of the engineered wood will be prepared by weighing them. The weight of the veneers is required for calculating the volume of the finished block of the engineered wood (e.g., 300 mm×300 mm) so that a predetermined density of the finished block can be achieved. This step (202) helps to achieve the required density and bonding strength of the end engineered wood. It will be appreciated that the volume of the finished block of engineered wood depends on the application and requirements. Consequently, the required weight of the veneers will depend on the desired volume of the finished block of engineered wood.

Step 9: Arranging the Veneers in the Selected Mould (203)

The female part 1304 of the mould will be set in a machine press. In a further embodiment of the invention, prior to the laying of veneers, an insulation material is placed between the mould and the veneers to ensure that the finished product can be released from the mould. Layers of veneers will be laid on top of the female part 1304 of the mould. In a further embodiment of the invention, each veneer is arranged in a unidirectional manner from edge to edge. In some embodiments, in the process (203) of arranging the veneers in the selected mould, all of the ends of the veneers meet. In some embodiments, approximately 600 layers of veneers are laid into the selected mould. In some embodiments, the layers of veneers are placed together in such a way that they simulate the growth pattern of a tree (or a shrub)—each layer of veneer represents an annual growth ring of a tree.

After all the layers of veneers are arranged in the mould, the male portion 1302 of the mould will be capped on top of the arranged bundle of veneers (veneer block 800). This will then be followed by placing a plate 1310 of a particular weight (e.g., steel plate) on top of the completed bundle of veneers. The veneers are then ready for pressing thereafter.

Step 10: Pressing (204)

Both the veneer block 800 comprising the layers of veneers and the mould that holds the veneer block 800 will be pushed into a machine press (also known as press machine) together. The machine press will then exert pressure on the steel plate 1310 that is capped on top of the veneer block 800. The veneer block 800 will then be compressed to achieve the predetermined shape and volume. Once the compression is completed, securing equipment such as steel pins will be secured into the mould to hold the compressed veneer block 800 at the predetermined shape and volume.

In a further embodiment of the invention, the mould that holds the veneer block 800 is placed inside a container 1306 having a plurality of holes 1307 in its side walls, which are configured to receive rods/pins 1308 (e.g., steel pins). A machine press then exerts pressure onto the plate 1310 to urge the male mould 1302 towards the female mould 1304 to compress the veneers, such that the plate 1310 is positioned below the corresponding holes 1307 in the side walls of the container 1306. Rods/pins 1308 are then inserted through the holes 1307 to retain the male portion 1302 of the mould in the desired position.

Depending on the application and requirements, the cross-section of the container 1306 can have different shapes, such as U shape (i.e., U cross-section) or circular shape (circular cross-section).

As the veneer fibres in the processed veneer 802 are softer in their tensile strength after the veneers have been perforated in Step 4 (104), the configurations of the pores/holes 804 in the veneers will be distorted to make the veneer block 800 have a more natural appearance 501.

In a further embodiment of the invention, after the veneer block 800 is laid between the male 1302 and female 1304 parts of the mould, a high-pressure clamp is used to press and hold the veneer block 800. In a further embodiment of the invention, the machine press can be a hot-press machine, cold-press machine, vacuum press machine or hydraulic press machine (e.g., a hydraulic clamping system).

Curing Phase (300)

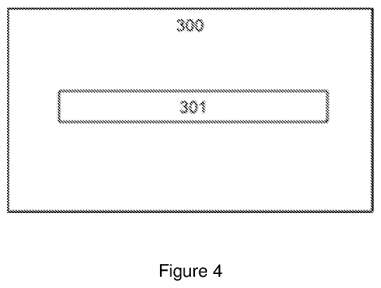

The Curing Phase 300 will be described in more detail as follows, with reference to FIG. 4.

Step 11: Curing the Compressed Veneer Block 800 (301)

The mould holding the compressed veneer block 800 will be transferred into a curing oven. It will be left in the curing oven for a period of time required for the curing process to complete. In some embodiments, the length of this time period is set from about 24 hours to about 36 hours depending on the requirements for the end product. During the curing process, the resin (or any other types of adhesive) within each veneer will react to heat and bind each and every layer of veneer together.

It will be appreciated that the method of curing will depend on the type of resin used. Other methods of curing include but are not limited to curing by electron beams, chemical additives, ultrasound and ultraviolet radiation. In various other embodiments, the resin is self-curing.

As the male 1302 and female 1304 portions include the contoured designs that mimic a desired wood species, the veneer block 800, being sandwiched by the male 1302 and female 1304 portions, will develop grain patterns that are similar or identical to natural wood grain patterns during the course of curing.

Once the curing phase is over, the securing equipment such as the steel pins is removed and a block of the engineered wood is generated. This block of the engineered wood can be further processed into its final product. The further processing steps include, but not limited to, slicing, moulding, routing, carving, sanding, bonding and a combination thereof.

Technical Advantages of the Present Invention

The present invention aims to provide an improved engineered wood that can be used as a preferred substitute of natural timber. Breaking down veneers to increase its porosity and tensible strength enables resin (or any other types of adhesive materials) to fully impregnate the veneers. After being assembled into a veneer block 800 via pressing and curing, the artificially created pores/holes will develop veneer boundaries that have a natural appearance similar to the annual growth rings observed in natural woods 501, and the resin (or any other types of adhesives) filling the holes/pores can prevent, for example, water molecules and termites, from penetrating into the veneers.

The present invention therefore simulates the exact appearance of the natural timber, and at the same time, addresses the common issues arising from using the natural timber, such as warping, rotting, and susceptibility to termite infestation.

The present invention has a natural appearance and thus might be chosen by users as a preferred substitute of the natural timber. Different from for example LVL and plywood, where the layers of veneer are visible, there is no repetition of wood grain patterns in the present invention. Slicing or cutting the invention is similar to cutting a natural timber, and the grains on the layer exposed from the cut will gradually change, closely resembling the grains on the natural timer. Every single cut piece from the invention block reveals natural wood grain patterns that are unique and of aesthetic value.

The present invention can also be processed into various shapes as an entire solid wood piece for curving, moulding or sanding. In clear contrast, when a LVL or a plywood is being cut or sliced, only the surface of the LVL or the plywood carries presentable grains similar to those in the natural wood—in the cross-sections of the LVL or plywood, both the cross-grains and the veneer layers are visible. Thus, neither LVL nor plywood can be utilized as a solid piece of wood.

In a preferred embodiment of the invention, sustainable poplar veneer from plantations is utilized to produce a naturally looking block with wood grain patterns that occur in exotic natural timber such as Oak, Teak, Rosewood and many other types of wood. The grain patterns for different woods are created using modules that are developed based on studying how different wood species grow.

The engineered wood of the present invention can also be used as a solid piece to carve out furniture, sculptures, handrails and more. The wood grain of the present invention is still visible even after such processing.

The engineered wood of the present invention is more dimensionally stable as compared to the conventional derivatives of engineered wood. For example, the present invention is less susceptible to warping, and it does not rot even exposed to harsh weather conditions.

A list of the advantages of the engineered wood of the present invention is summarized in Table. 1 below:

TABLE 1
The Technical Advantages of the Present Invention

| Aspect | Advantages |
|---|---|
| Appearance | having more natural appearance as compared |
| | to other conventional derivatives of |
| | engineered wood; |
| | having much higher aesthetic value as |
| | compared to other conventional derivatives |
| | of engineered wood, as the wood grains of |
| | the invention look very natural. |
| | Duplication of natural wood grains with |
| | high aesthetic value and quality, based on |
| | images analysed and transformed by a |
| | software onto the engineered wood, through |
| | the operation of a CNC machine to produce |
| | the male and female moulds. The male and |
| | female moulds are contoured according to |
| | the desired wood grains and growth rings. |
| | The veneers can be dyed to desired |
| | colours of woods such as teak, ebony and |
| | rosewood, for example prior to resin |
| | impregnation and/or through the addition |
| | of colour pigments to the resin. This |
| | process produces homogenised solid wood |
| | throughout the thickness, width and length |
| | of the engineered wood. |
| Processing | can be treated just like a solid piece of |
| | natural timber; |
| | compatible with most general wood coating; |
| | can be processed with conventional |
| | woodworking equipment which includes |
| | moulding, routing, carving, sanding and |
| | bonding. |
| Durability | Having minimum warping even under harsh |
| | weather conditions |
| | Fire resistant |
| | Termite free and/or termite resistant |
| | Moisture resistant |

Fire Resistance Test

A large scale surface spread of flame test was conducted on the present invention (according to the British Standard 476: Part 7: 1997) to evaluate its fire resistant property. There were six specimens in total, each of nominal test size of 885 mm×270 mm. The adhesive used to bond the layers of veneers together was phenolic adhesive comprising phenol (<2%) and formaldehyde (<1%), and having the following properties:

| | Typical Value |
|---|---|
| Viscosity @ 25° C. | 30 mPa · s |
| Non-volatile | 49% |
| constituents @ 120° C. | |
| pH value @ 25° C. | 9.4 |

The bulk density of the specimen was approximately 963 kg/m³.

The six specimens, backed with calcium silicate board, were tested with either face exposed to the specified thermal radiation from the apparatus described in paragraph 6.1 of the Standard. The intensity of the radiated heat incident on the specimen varies with distance from the hotter end, so that when the specified calibration panel is mounted in the place to be occupied by the specimen, the irradiance of the radiometer is as given in Table. 2 below. The test was terminated when the flame front reached the 825 mm reference line, or after 10 minutes has elapsed, whichever is the shorter.

TABLE 2
Irradiance along Horizontal Reference
Line on the Calibration Board

| Distance along | | | |
|---|---|---|---|
| reference line | | | |
| from inside edge | | | |
| of specimen holder | Irradiance kW/m² | | |
| mm | specified | min. | max. |
| 75 | 32.5 | 32.0 | 33.0 |
| 225 | 21.0 | 20.5 | 21.5 |
| 375 | 14.5 | 14.0 | 15.0 |
| 525 | 10.0 | 9.5 | 10.5 |
| 675 | 7.0 | 6.5 | 7.5 |
| 825 | 5.0 | 4.5 | 5.5 |

TABLE 3
Results of the Fire Resistance Test

| Specimen No. | 1 | 2 | 3 | 4 | 5 | 6 |
|---|---|---|---|---|---|---|
| Spread of | 0 | 0 | 0 | 0 | 0 | 0 |
| flame at | | | | | | |
| first 1½ | | | | | | |
| minutes (mm) | | | | | | |
| Distance (mm) | Time of spread of flame | | | | | |
| | to indicated distance (minutes · seconds) | | | | | |
| Start of | 5.20 | 4.01 | 3.14 | 3.41 | 3.05 | 5.15 |
| flaming | | | | | | |
| 75 | — | — | 4.25 | — | — | — |
| 165 | — | — | — | — | — | — |
| 190 | | | | | | |
| 215 | | | | | | |
| 240 | | | | | | |
| 265 | | | | | | |
| 290 | | | | | | |
| 375 | | | | | | |
| 455 | | | | | | |
| 500 | | | | | | |
| 525 | | | | | | |
| 600 | | | | | | |
| 675 | | | | | | |
| 710 | | | | | | |
| 750 | | | | | | |
| 785 | | | | | | |
| 825 | | | | | | |
| 865 | | | | | | |
| Time of | 10.00 | 10.00 | 10.00 | 10.00 | 10.00 | 10.00 |
| maximum | | | | | | |
| spread of | | | | | | |
| flame | | | | | | |
| (minutes · | | | | | | |
| seconds) | | | | | | |
| Distance of | 0-75 | 0-75 | 75-165 | 0-75 | 0-75 | 0-75 |
| maximum | | | | | | |
| spread of | | | | | | |
| flame (mm) | | | | | | |
| Comments | | | | | | |

TABLE 4
Classification of Surface Spread of Flame

| | Spread of | | | |
|---|---|---|---|---|
| | flame at 1.5 min. | | Final spread of flame | |
| | | Limit for one | | Limit for one |
| | Limit | specimen in | Limit | specimen in |
| Classification | (mm) | sample (mm) | (mm) | sample (mm) |
| Class 1 | 165 | 165 + 25 | 165 | 165 + 25 |
| Class 2 | 215 | 215 + 25 | 455 | 455 + 45 |
| Class 3 | 265 | 265 + 25 | 710 | 710 + 75 |

| | |
|---|---|
| Class 4 | Exceeding the limits for class 3 |

In accordance with the classification definitions specified in the British Standard 476: Part 7: 1997 (Table. 4), the test result (Table. 3) shows that the samples of the present invention tested have Class 1 surface spread of flame, as all samples' final/maximum spreads of flame were lower than 165 mm.

Termite Resistance Test

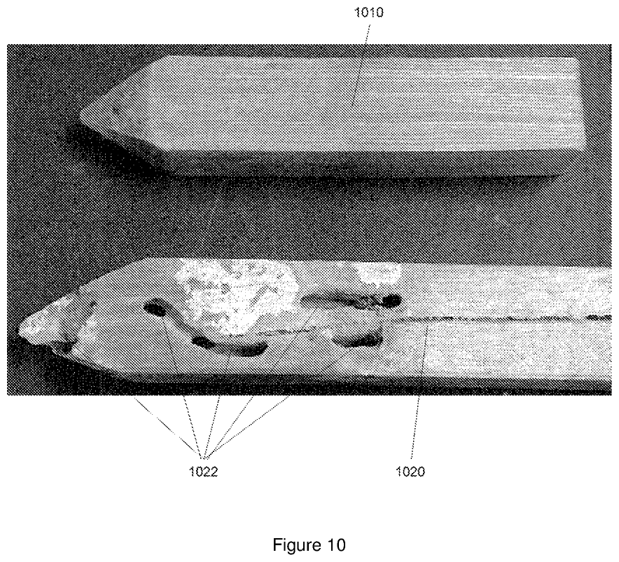

As illustrated in FIG. 10, after placing samples 1010 of the present invention in a termite nest in Darwin Australia for six months, there was no visible termite infestation or wood damage. In contrast, the control (Australian hardwood) 1020 suffered extensive termite infestation and damages 1022 after being left in the termite nest in Darwin Australia for six months.

General Property Test

The physical properties testings (according to the standard ASTM D 1037) were conducted on multiple samples of an embodiment of the present invention (made from compressed poplar, pine or eucalyptus veneer, with phenolic glue, and cured at 180 degrees Celsius for 24 hours. A summary of the averaged results is presented in Table. 5.

TABLE 5
The Averaged Results of the Physical Properties
of an embodiment of the Present Invention

| | Results | | Results | |
|---|---|---|---|---|
| Property | (Standard) | | (Metric) | |
| Density | 54.1 | lbs/ft³ | 865.8 | kg/m³ |
| Maximum Crushing | 10,297 | psi | 71.0 | MPa |
| Strength | | | | |
| Shear Strength | 967 | psi | 6.7 | MPa |
| Work to Maximum | 7.72 | lbf in/in³ | 0.05N | mm/mm³ |
| Load | | | | |
| Janka Hardness | 1,583 | lbf | 7,042N | |
| Bending Strength | 13,714 | psi | 94,557 | kPa |
| (MOR) | | | | |
| Strength Retention | 101.5% | | 101.5% | |
| after Aging | | | | |
| Modulus of | 1,989,797 | psi | 13,719,167 | kPa |
| Elasticity (MOE) | | | | |
| Screw Withdrawal | | | | |
| Face | 646 | lbf | 2,875N | |
| Edge Perpendicular | 672 | lbf | 2,991N | |
| to Long Side | | | | |
| Edge Parallel to | 513 | lbf | 2,284N | |
| Long Side | | | | |
| Dimensional Stability | | | | |
| 50%-90% R.H.: | | | | |

| | | |
|---|---|---|
| Length Expansion | 0.07% | 0.07% |
| Width Expansion | 0.204% | 0.204% |
| Thickness Swell | 0.373% | 0.373% |

As shown in Table. 5, the present invention shows moisture-resistant property: even in an environment with a relative humidity (R.H) from 50%-90%, the changes in the present invention's dimensions were small.

TABLE 6
Comparing the Physical Properties of the Present Invention with Natural Timbers

| Standard | | | MERANTI, | | | | | |
|---|---|---|---|---|---|---|---|---|
| Name | INVENTION | | LIGHT RED | KAPUR | MERBAU | | BALAU | |
| Wood | Engineered | | Light | Medium | Heavy | | Heavy | |
| Type | Wood | | Hardwood | Hardwood | Hardwood | | Hardwood | |
| Air-dry | 865.8 | kg/m³ | 385-755 | 575-815 | 515-1,040 | | 850-1,155 | |
| density | | | kg/m³ | kg/m³ | kg/m³ | | kg/m³ | |
| Static | 13,179 | mPa | 8,400- | 13,000- | 15,400 | mPa | 20,100 | mPa |
| Bending | | | 13,600 mPa | 18,700 mPa | | | | |
| MOE | | | | | | | | |
| Static | 94,557 | kPa | 63,000- | 114,000- | 116,000 | kPa | 142,000 | kPa |
| Bending | | | 83,000 kPa | 126,000 kPa | | | | |
| MOR | | | | | | | | |
| Shear | 6,700 | kpa | 630 kPa- | 10,500- | 12,500 | kPa | 15,000 | kPa |
| Strength | | | 11,000 kPa | 13,600 kPa | | | | |

| | | | | | |
|---|---|---|---|---|---|
| Durability | Very | Non- | Moderately | Durable | very |
| | durable | durable | durable | | durable |

As shown in Table. 6 above, the present invention shows physical properties similar to natural timbers such as Meranti (Light Hardwood), Kapur (Medium Hardwood) and Merbau (Heavy Hardwood), and at the same time, demonstrates superior durability.

As demonstrated in the above tests, the present invention has unique technical advantages that other conventional derivatives of engineered wood cannot achieve.

Furthermore, although the source materials of the present invention can be economic sustainable plantation wood species, the end product of the present invention can be moulded and restructured to mimic exotic wood species. Thus, the present invention can be used as an alternative to the natural woods.

The above is a description of embodiment(s) of method for producing an engineered wood. It is to be further appreciated by a person skilled in the art that features from one or more embodiments as described may be permutated and/or combined to form further embodiments without departing from the scope of the present invention. In particular:
in the step of breaking down the veneer, instead of using studded wheels to break down the veneer, a person skilled in the art might use other physical apparatuses (e.g., laser machine operable to burn holes on the veneer; high-pressure gas-ejector or water-ejector) or chemical/biological substances (e.g., cellulase; mild acids) to perforate the veneer.
in the step of drying the veneer, a person skilled in the art might dry the veneer in the air or in a specialized chamber. Further, the drying method adopted by a person skilled in the art might include, but not limited to, natural air-drying, hot air-drying, drum drying, vacuum drying and dielectric drying.
Depending on the application and requirement, the cross-sectional shape of the pore or hole in the veneer can be any shape (for example a circle, square, rectangle or triangle) which can correspond to the shape of the studs or spikes on the wheel (or roller) used to form these pores/holes. If the cross-sectional shape of the pore or hole in the veneer is round, it will be understood that the surface length (i.e. length of the major axis) and the surface width (i.e. the length of the minor axis) are the same.

1. A method of producing an engineered wood, comprising the steps of:
(a) breaking down a veneer to increase its porosity;
(b) impregnating the veneer from step (a) with an adhesive material;
(c) drying the veneer from step (b) to a predetermined moisture content level;
(d) arranging a plurality of the veneers from step (c) in a mould; and
(e) pressing the plurality of the veneers in the mould.

2. The method according to claim 1, wherein step (a) comprises perforating the veneer with holes that penetrate through the veneer.

3. The method according to claim 2, wherein each of the holes has a depth of about 0.5 mm to about 3 mm, a surface length of about 2 mm to about 5 mm, and a surface width of about 0.2 mm to about 1 mm.

4. The method according to claim 2 or 3, wherein step (a) comprises the porosity of the veneer is of at least five (5) holes per cm² square centimeters of the veneer.

5. The method according to any of the preceding claims, the method further comprises arranging the plurality of veneers to simulate a natural wood grain pattern.

6. The method according to any of the preceding claims, the method further comprises selecting a mould with a natural wood grain pattern.

7. The method according to claim 6, wherein the mould comprises a male portion and a female portion, wherein a surface contour of the male portion complements a surface contour of the female portion.

8. The method according to claim 7, wherein step (d) comprises arranging the plurality of veneers in-between the male portion and the female portion.

9. The method according to any of claims 6 to 8, wherein the mould is produced by a robotic computer numeric control machine.

10. The method according to any of the preceding claims, further comprises placing the mould holding the plurality of veneers into a container after step (d) and prior to step (e), wherein the sidewall of the container has a plurality of holes configured to receive at least one rod or pin.

11. The method according to any of the preceding claims, wherein step (a) comprises breaking down the veneer with at least one studded wheel.

12. The method according to any of the preceding claims, wherein the method further comprises rotary peeling the veneer from a wood prior to step (a).

13. The method according to any of the preceding claims, further comprises drying the veneer to a moisture content level of about 5% to about 18% prior to step (a).

14. The method according to any of the preceding claims, wherein the method comprises trimming the veneer to a width of about 150 mm to about 300 mm prior to step (a).

15. The method according to any of the preceding claims, wherein step (b) comprises soaking the veneer in the adhesive material for about 12 to about 24 hours.

16. The method according to any of the preceding claims, wherein step (b) further comprises placing the veneer and the adhesive material in a vacuum pressure impregnation chamber for about 3 to about 4 hours.

17. The method according to any of the preceding claims, further comprises weighing the plurality of the veneers.

18. The method according to any of the preceding claims, further comprises inspecting the plurality of the veneers to remove one or more defective veneers.

19. The method according to any of the preceding claims, wherein the adhesive material comprises a resin having a viscosity of about 5 to about 30 cP.

20. The method according to claim 19, wherein the resin is a polyester, polyacrylate, polyurethane, polyamide, polylactone, polycarbonate, polyolefin, polyvinyl acetate, alkyd, oil-modified alkyd, epoxy resin, resin with pendent olefinic groups, lacquer resin, cellulose ester, melamine resin, or phenolic resin, or a combination thereof.

21. The method according to any of the preceding claims, wherein the method further comprises curing the plurality of the veneers for about 24 to about 36 hours.

22. An engineered wood formed from a plurality of veneers, wherein each of the plurality of veneers comprises a plurality of fully-penetrated holes, and an adhesive material adapted to bind the plurality of veneers together by filling the plurality of fully-penetrated holes.

23. The engineered wood according to claim 22, wherein the plurality of the veneers are arranged to simulate a natural wood grain pattern.

24. The engineered wood according to claim 22 or 23, wherein each of the fully-penetrated holes comprises a depth of about 0.5 mm to about 3 mm, a surface length of about 2 mm to about 5 mm, and a surface width of about 0.2 mm to about 1 mm.

25. The engineered wood according to any of claims 22 to 24, wherein the plurality of fully-penetrated holes are randomly distributed across each of the plurality of veneers.

26. An engineered wood according to any of claims 22 to 25, wherein each of the plurality of veneers comprises a porosity of at least five (5) fully-penetrated holes per square centimeters.

27. The engineered wood according to any one of claims 22 to 26, wherein the adhesive material comprises a resin.

28. The engineered wood according to claim 27, wherein the resin is selected from one or more of a polyester, polyacrylate, polyurethane, polyamide, polylactone, polycarbonate, polyolefin, polyvinyl acetate, alkyd, oil-modified alkyd, epoxy resin, resin with pendent olefinic groups, lacquer resin, cellulose ester, melamine resin or phenolic resin.

29. The engineered wood according to any one of claims 22 to 28, wherein the engineered wood has a natural appearance.

30. The engineered wood according to any one of claims 22 to 29, wherein the engineered wood is adapted to be moulded, routed, carved, sanded and/or bonded.

31. The engineered wood according to any one of claims 22 to 30, wherein the engineered wood is resistant to warping, rotting, moisture, fire and/or termite infestation.

32. An engineered wood produced from a method according to any one of claims 1 to 21.
